(19) United States
(12) Patent Application Publication
(10) Pub. No.: US 2023/0236109 A1
(43) Pub. Date: Jul. 27, 2023

(54) Dual-Emitter Optic Block and Chamber for Smoke Detector

(71) Applicant: Excelitas Canada, Inc., Vaudreuil-Dorion (CA)

(72) Inventors: JinHan Ju, Kirkland (CA); Sven Stoettinger, Mainz (DE)

(21) Appl. No.: 17/582,056

(22) Filed: Jan. 24, 2022

(51) Int. Cl. G01N 15/14

(52) U.S. Cl. CPC G01N 15/1456; G01N 15/1434; G01N 2015/0046

(57) ABSTRACT

A photo-electric smoke detector assembly includes a Y-shaped optic block with a first photo-electronic device mounted on a first end and second and third photo-electronic devices mounted on a second end, with an interaction volume at a midpoint. Two of the photo-electronic devices direct pulses of differing wavelengths toward the interaction volume, and the remaining photo-electronic device receives light from the pulses scattered off of smoke particles in the interaction volume.

### FIELD OF THE INVENTION

The present invention relates to smoke detection, and more particularly, is related to a smoke detector chamber with dual emitters.

### BACKGROUND OF THE INVENTION

Different types of smokes produced from different material burning have particulate matter distributions of different sizes. Certain wavelengths of light work better for detecting certain particle size ranges, for instance, IR (infrared) light works better for larger smoke particle while blue light works better for smaller smoke particles.

Smoke detecting devices typically detect smoke particles in a chamber between a light emitting source and a light detector. Traditional smoke detecting devices incorporate an optic block assembly that emits and detects a single wavelength, for example, using an infrared (IR) light emitting diode (LED) as the emitter. FIGS. 1A and 1B show an exemplary optic block assembly 100 of a traditional smoke detector. The optic block assembly 100 is disposed within a chamber (not shown) of the smoke detector. An emitter 110 periodically emits an IR pulse 140 through an emitter channel 121 toward an interaction volume 141. The IR pulse 140 collides with smoke particles within the interaction volume 141 and the collisions scatter reflected beams 142 in random directions. At least some of the scattered beams travel through a detector channel 125 toward the photodetector 150. The signal produced by the photodetector is monitored for the presence of received scattered beams. However, it is difficult to differentiate between small and large smoke particles using a single wavelength.

More recently, smoke detector have been developed that emit both IR and blue light to detect the presence of different sized smoke particles. The optics block of such detectors produces a smoke signal ratio of the two wavelengths, which is a function of the smoke particles dimensions (types of fire), thus permitting the user to improve the detection selectivity between small smoke particles and large smoke particles via the smoke detection algorithms. The dual color allows a reduction in the smoke detection threshold.

However, the present dual wavelength smoke detector require additional components and tighter manufacturing tolerances resulting in increased costs. Therefore, there is a need in the industry to address one or more of the abovementioned issues.

### SUMMARY OF THE INVENTION

Embodiments of the present invention provide a dual-emitter optic block and chamber for a smoke detector. Briefly described, the present invention is directed to a photo-electric smoke detector assembly that includes a Y-shaped optic block with a first photo-electronic device mounted on a first end and second and third photo-electronic devices mounted on a second end, with an interaction volume at a midpoint. Two of the photo-electronic devices direct pulses of differing wavelengths toward the interaction volume, and the remaining photo-electronic device receives light from the pulses scattered off of smoke particles in the interaction volume.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1A is a schematic diagram showing an exemplary optic block assembly of a traditional smoke detector from a perspective view.

FIG. 1B is a schematic diagram of the optic block assembly of FIG. 1A from a cutaway side view.

FIG. 2A is a schematic diagram showing an exemplary optic block assembly for a first embodiment of a smoke detector from a perspective view.

FIG. 2B is a schematic diagram of the optic block assembly for the smoke detector of FIG. 2A from a cutaway side view.

FIG. 2C is a cutaway view of FIG. 2A.

FIG. 2D is a side view showing a first plane of optical paths of the optic block assembly FIG. 2A.

FIG. 2E is a top view showing a second plane of optical paths of the optic block assembly FIG. 2A.

FIG. 2F shows the difference in surface reflection direction between the rounded shape of previous detectors and the flat tunnel of the first embodiment.

FIG. 3 is an exploded view of the first embodiment smoke detector.

FIG. 4 is a cutaway side view of the first embodiment smoke detector shown relative to a view of the chamber cap interior.

FIG. 5 is a schematic diagram showing a second embodiment of an optical block for a smoke detector.

FIG. 6 is a flowchart of an exemplary method embodiment for forming a smoke detector.

FIG.7 is a schematic diagram illustrating the field of illumination, the field of view, and a cross section plane of the interaction volume of the optical block of FIG. 2A.

FIG. 8 shows a top plot of the interaction volume of a previous optical block with rounded light tunnels, and a bottom plot of the interaction volume of the optical block of the first embodiment.

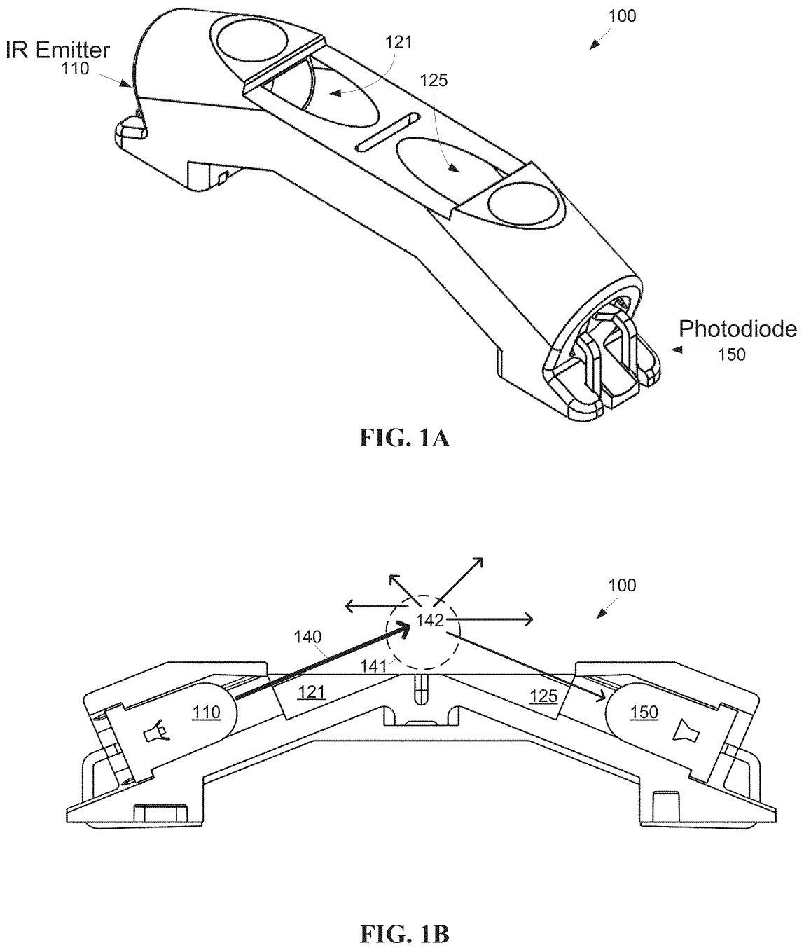

### DETAILED DESCRIPTION

The following definitions are useful for interpreting terms applied to features of the embodiments disclosed herein, and are meant only to define elements within the disclosure.

As used within this disclosure, an “interaction volume” refers to a volume of space where the field of illumination of one or more smoke detector emitters intersects with the field of view of a smoke detector light sensor. The interaction volume is determined as a volume overlap of the illumination and detection optical path. The value of the interaction volume for each volume element depends on the field of illumination of the light source and field of view of the detector. High field densities are prone to mechanical tolerances such as pointing errors that lead to a significant signal loss once the foci of the field of view and the field of illumination do not coincide. A more homogeneous interaction volume shows less signal loss if the optical axes of emitter and detector are not perfectly aligned.

As used within this disclosure, a “hotspot” refers to a (typically small) volume element with high interaction volume values (therefore high density regions) due to coinciding foci of field of illumination and field of view, for example, as a result of round-shaped optical sensitive areas of the previous designs.

As used within this disclosure, a “photo-electronic device” refers to both light emitting and light detecting electronic devices, for example, LED devices and photodiodes. Detectors with more than one LED emitter may include LED emitters emitting two or more different wavelength ranges of light, for example, infrared (IR) and visible blue light.

Reference will now be made in detail to embodiments of the present invention, examples of which are illustrated in the accompanying drawings. Wherever possible, the same reference numbers are used in the drawings and the description to refer to the same or like parts.

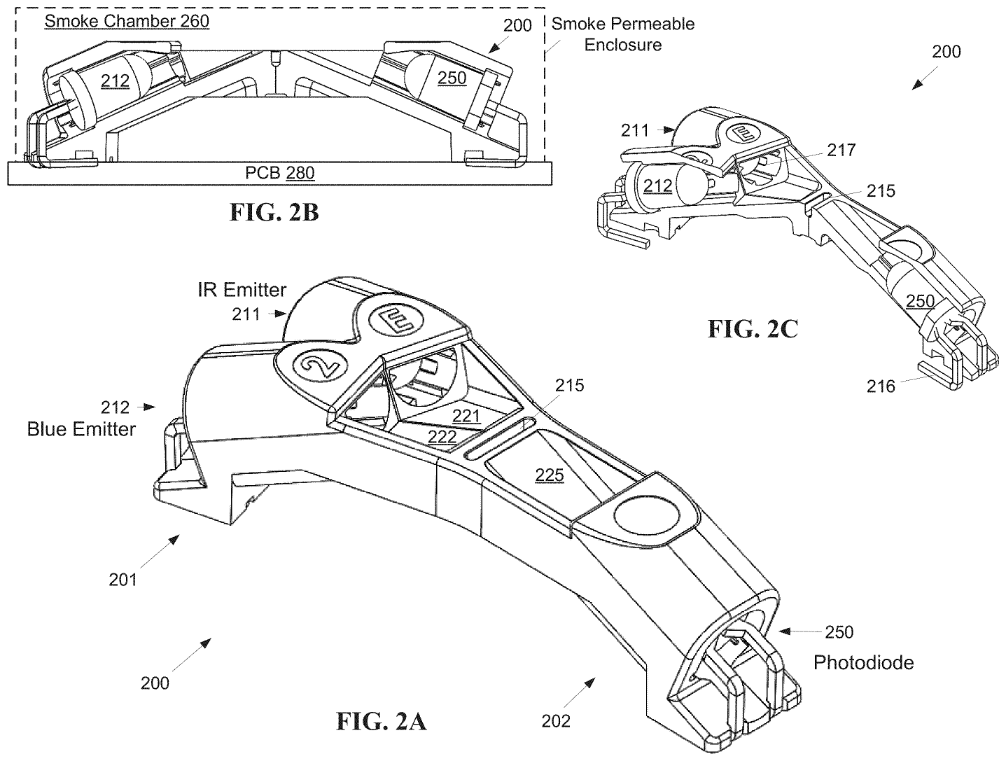

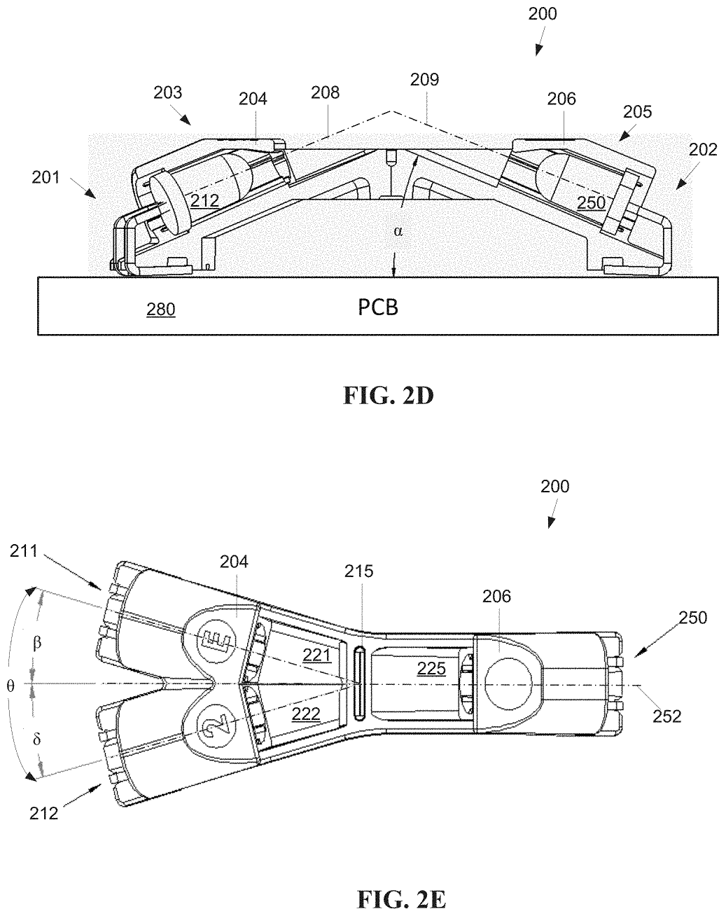

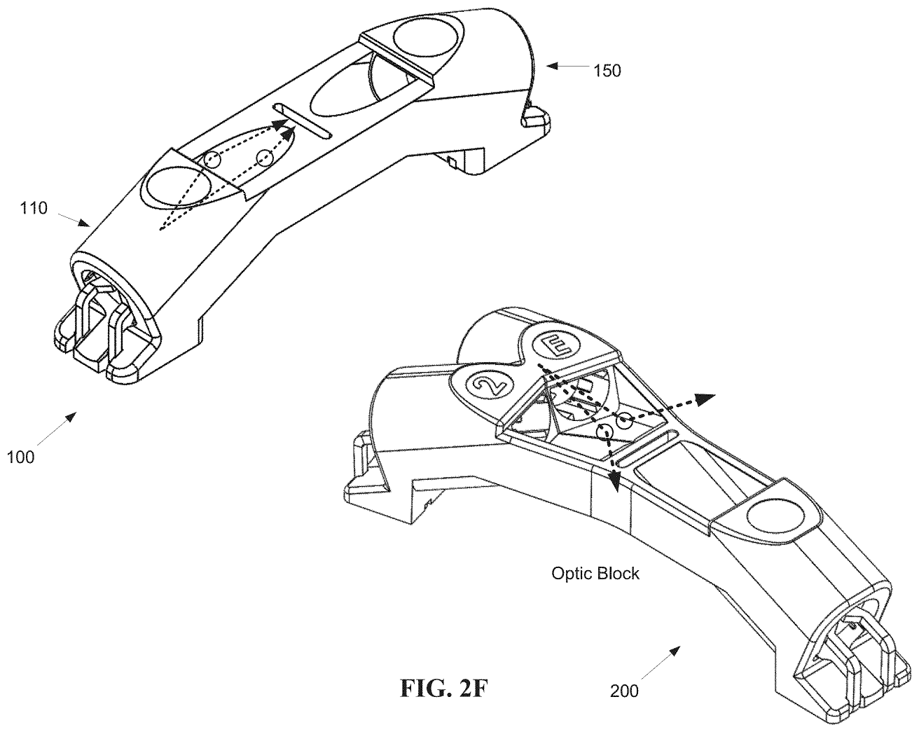

Embodiments of the present invention are directed to a photo-electric device having photo-electronic devices including one or two emitters and one photodetector integrated into one plastic optic block assembly, for example as a surface mountable device (SMD) to be solder reflow mounted to a printed circuit board (PCB) for smoke detection. As noted in the background section, the optic block for previous smoke detectors may include one light emitter and one optical detector where a single wavelength optical signal may not be able to differentiate between small and large smoke particles. FIGS. 2A-2C show an optic block 200 for a first embodiment smoke detector that has dual light emitters 211, 212, where the use of both an IR LED emitter 211 and a blue LED emitter 212 improves the ability of the smoke detector to selectively detect small and large smoke particles, for example, generated from different burning materials. The shorter wavelength of the blue LED allows for better detection of smaller particles which are produced by fast burning Polyurethane fires, and also the use of a dual wavelengths (IR and Blue) optics block produces a smoke signal ratio of the two wavelengths that can improve the detection sensitivity to differentiate between small smoke particles and large smoke particles.

The embodiments include a particularly configured Y shape optic block 200 (Y-block Assembly) with two emitters 211, 212 and one photodetector 250 and a particularly shaped smoke chamber designed around the Y-block assembly, used in smoke detection. Under the first embodiment, a first end 201 of the optic block 200 houses the emitters 211 while a second end 202 opposite the first end 201 houses a photo detector 250, for example, a photodiode. The first emitter 211 and the second emitter 212 alternately generate a short duration light pulse. The optic block 200 includes a dust collector 215 configured as a slot recessed into the optic blot 200 located at a midpoint of an intersection portion of field of view of the emitters 211, 211 and the detector 250. The photodiode 250 may receive light from the light pulses scattered within the interaction volume off of smoke particles in the smoke chamber 260.

As shown by FIG. 2D, the optic block 200 is configured to be mounted to a substrate 280, for example, a printed circuit board (PCB). The optic block 200 is configured to mount the emitters 211, 212 so they emit respective light beams along an emitter optical axis 208 oriented at an angle α with respect to a planar mounting surface of the substrate 280, for example the angle α may be in the range of 20 to 25 degrees. Each emitter 211, 212 is seated in a respective emitter mounting region 203 of the optic block 200, where an emitter cap 204 may be affixed to the optic block to prevent stray light from entering the chamber 260. A first emitter channel 221 aligned with the IR emitter optical axis has a flat channel floor parallel to the IR emitter optical axis 208. A second emitter channel 222 aligned with the blue emitter optical axis has a flat channel floor parallel to the blue emitter optical axis 208.

Likewise, the optic block 200 is configured to mount the photo detector 250 so the photo detector 250 receives light along the detector axis 209 oriented at the angle α with respect to the planar mounting surface of the substrate 280.

Metal leads 216 of the photo-electronic components 211, 212, 250 may formed in J shape (so called J leads) and photo-electronic components are inserted into plastic body of the optic block 200. The optic block plastic body may include crush ribs 217 configured to hold the photo-electronic components 211, 212, 250 in the optic block 200 at certain strength for example, on the order of about 1 Kg pull force, so the photo-electronic components 211, 212, 250 stay in position during a high temperature solder reflow of optical block 200 on the PCB 280. A detector channel 225 aligned with the detector axis 209 has a flat channel floor parallel to the photo detector optical axis. The channel floors 221, 222, 225 are optically sensitive areas arranged to follow the same angle of each corresponding optical component pointing direction, for example 22.5 degrees off the PCB plane. The optical sensitive areas may be, for example, flat along the optical axis, having a polished surface to have controlled light reflection out from the emitters 211, 212 and toward the photodetector 225. The configuration of the optical sensitive areas 221, 222, 225 helps reduce the interaction volume density to avoid hotspots.

FIG. 2F shows the difference in surface reflection direction between the rounded shape of previous detectors and the flat tunnel of the first embodiment. The overall sensitivity of the smoke detector 300 depends on the overlap of the emitter field of illumination and the field of view of the detector. In the previous optic block 100 a light tunnel having a round shaped profile was commonly used that served to focus a portion of the emitter emission field and the detectors field of view towards a spatial location in the center of the optic block resulting in a concentrated interaction volume of small spatial dimension and high field density with the goal of a strong local overlap of both fields. The function of the rounded light tunnel here can be compared with that of a partial parabolic concentrator mirror. The flat light tunnels 221, 222, 225 in the present embodiments do not alter the path of the emission field or detector field of view towards a jointly center, so the interaction volume is a result of the angular field of the emitters 211, 212 and the photodetector 250.

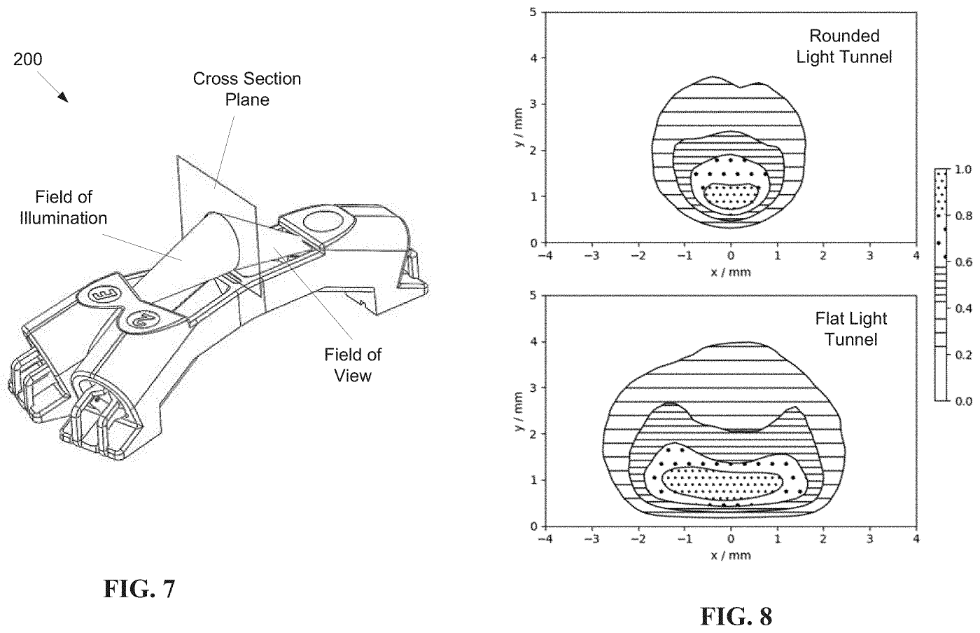

FIG.7 illustrates the field of illumination, the field of view, and a cross section plane of the interaction volume of the optical block 200. FIG. 8 shows a top plot of the interaction volume of a previous optical block 100 with rounded light tunnels, and a bottom plot of the interaction volume of the optical block 200 of the first embodiment. While in the previous design an interaction volume with small spatial dimensions and high field density was present, the present embodiments provide a more extended and homogeneous interaction volume which enables a more robust smoke sensitivity signal with regards to geometrical variances that result in pointing errors for emitter or sensor without sacrificing overall sensitivity.

As shown in FIG. 2E, the first emitter 211 is arranged in an in-plane angle β (for example, in a range of 0 to 90 degrees) off a centerline 252 of the photodiode 250, and the second emitter 212 is arranged in an in-plane angle δ (for example, in a range of 0 to 90 degrees) off the centerline 252. While FIG. 2E shows angles β and δ are 15 degrees, in alternative embodiments angles β and δ may be different and may be or may not be in symmetric arrangement, depending on different applications.

An angle θ between the infrared LED angle and the blue LED angle is equal to β+δ in a plane parallel to a mounting plane of the optical block 200. The angular configuration as well as the shape and surface texture finish of optically sensitive areas 221, 222, 225 are configured to have a desirable interaction volume of the emitter and detector field of view, providing a good signal level for the emitted/scattered light in the presence of smoke, while still keep the low cost of plastic Y-block manufacturing and friendly components insertion process. For example, the flat surfaces of the optically sensitive areas 221, 222, 225 (“light tunnels”) result in a more homogeneous interaction volume that reduces “hot spot” features. The surface texture finish of the light tunnels 221, 222, 225 may be reflective (“glossy”) to ensure light at the interaction volume shows specular reflection and not surface scattering that would lead to reduction of the interaction volume. Compared with previous optic blocks, the Y-block assembly has a larger and more homogeneous interaction volume, which reduces the impact of geometrical variances on the smoke signal sensitivity. For example, the configuration of the Y-block assembly may mitigate pointing error of the emitter or of the sensor due to mechanical or placement (led-die, photo diode-chip) tolerances. The geometrical variances also include the variance of optical axis of emitters and detector due to the dimensional difference of plastic optic blocks, and relative positioning difference of emitters and detector mounted in optic blocks.

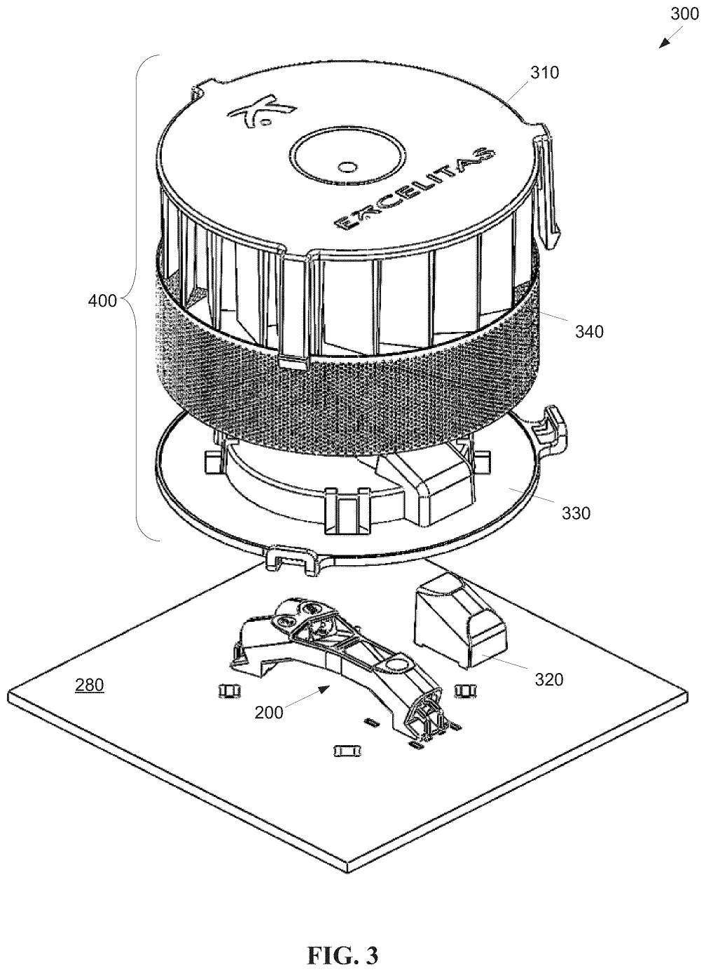

FIG. 3 is an exploded view of the first embodiment smoke detector 300. The smoke detector 300 includes three major subassemblies: 1) the SMD optic block 200 including the LEDs, the photodiode and the dust collector, the LEDs and the photodiode creating a large interaction volume, 2) the smoke chamber cap 400 having a roof 310 with a cone and circular structure and 3) a smoke chamber base 330 the smoke chamber cap 311 snap fits upon, where the smoke chamber base 330 integrates with the optic block 210 so that the optics 211, 212, 250 “see” into the smoke chamber 260.

The optic block 200 is mounted on a substrate (PCB) 280, for example in either a surface mount or thru-hole configuration. An electromagnetic interference (EMI) shield 320 may be configured to fit over the photodiode end 202 of the optic block 200. A smoke chamber assembly 400 includes a roof 310, a base 330 and a surrounding metal mesh 340. The metal mesh 340 is integrated with the smoke chamber, to screen insects and large dust particles from entering the smoke chamber and triggering the smoke detector.

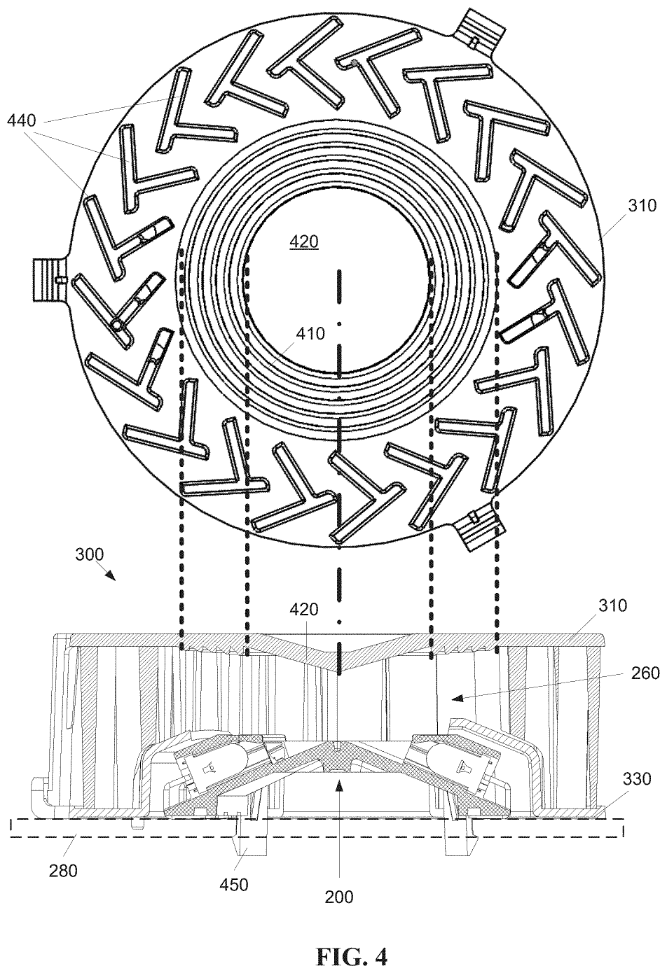

FIG. 4 illustrates the smoke chamber roof structure designed to optimize clean air signals providing a high smoke signal to background ratio, enabling high sensitivity for smoke detection. A central cone structure 420 operates in conjunction with a light labyrinth 440 to effectively guide extraneous light not scattered by smoke particles away from the photodetector 250 so the extraneous light does not contribute to the smoke signal. The angle of the central cone 420 (relative to the plane of the roof 310) may be, for example, on the order of 14°-20° with a minimum distance from an apex of the cone structure 420 to a middle section of the optic block 200 approximately 5 mm.

In order to still have a detectable background signal to assess the health status of the photo-electric device, additional concentric circular structures 410 surrounding the central cone structure 420 on the interior of the chamber cap roof and protruding into the chamber introduce light pathways towards the photodiode with low energy per pathway contribution due to steep reflection angles (for example, angles 45° or greater) and multiple reflection introducing light traps.

Meanwhile the level of background signal may be controlled by varying specific parameters of the light reflecting feature 410 to allow the end customers to have specific background levels for their device health assessment. Such parameters may include, for example, angle of circular features, height of circular features, and surface roughness of circular features. The combination of the angle change and distance change causes light reflection and scattering to have different background signal levels.

The configuration of the cone 420 and the circular structures 410 significantly reduce the transferred power compared to previous cap interior linear groove structures according to optical simulations and smoke tunnel tests.

The labyrinth 440 is formed from a plurality of interleaved baffles integrated into the smoke cap 400 for smooth air and smoke flow while blocking direct ambient light from entering the chamber 260. The smoke cap may be configured with legs 450 that easily snap into receiving apertures in the PCB 280.

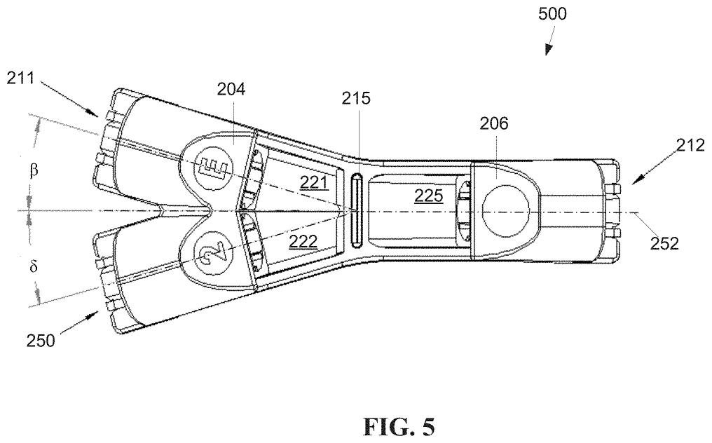

FIG. 5 shows a second embodiment of an optical block 500 for a smoke detector. Under the second embodiment a first emitter 211 and the photodiode 250 are co-located on a first side of the optical block 500 and a second emitter 212 is located on a second side of the optical block 500 opposite the first side. Under the second embodiment the photodiode 250 detects light from the first emitter 211 backscattered by smoke particles, and the photodiode 250 detects light from the second emitter 212 forward scattered by smoke particles. The back scattering arrangement of one emitter to allows the photodetector to detect some particular particles, for example dust particles or salt crystals that have different light scattering characteristics and give more back scattering light than other particles.

Under the first and second embodiments, the optic block assembly 200 is surface mountable to be solder reflowed on the PCB 280. Likewise, the EMI shield 320 for the photodiode 250 may be surface mounted together with the optic block assembly 200 on the same PCB 280. The EMI shield 320 and optic block assembly may be configured as solder reflow-able surface mount devices (SMD). In alternative embodiments, other PCB mounting techniques may be used, for example, through-hole mounting.

Under the embodiments described herein, the material for the optic block may include, but is not limited to glass reinforced polyethylene terephthalate for injection molding, and the material for the chamber (cap and base) may include antistatic ABS for injection molding.

In alternative embodiments, the smoke detector optic block may be substantially similar to the first embodiment but instead having a single emitter opposite a single photo detector, where the emitter and detector have flat optical channels and the chamber roof includes the central protruding cone structure and the concentric circular structures surrounding the central cone structure. Other variations are also possible.

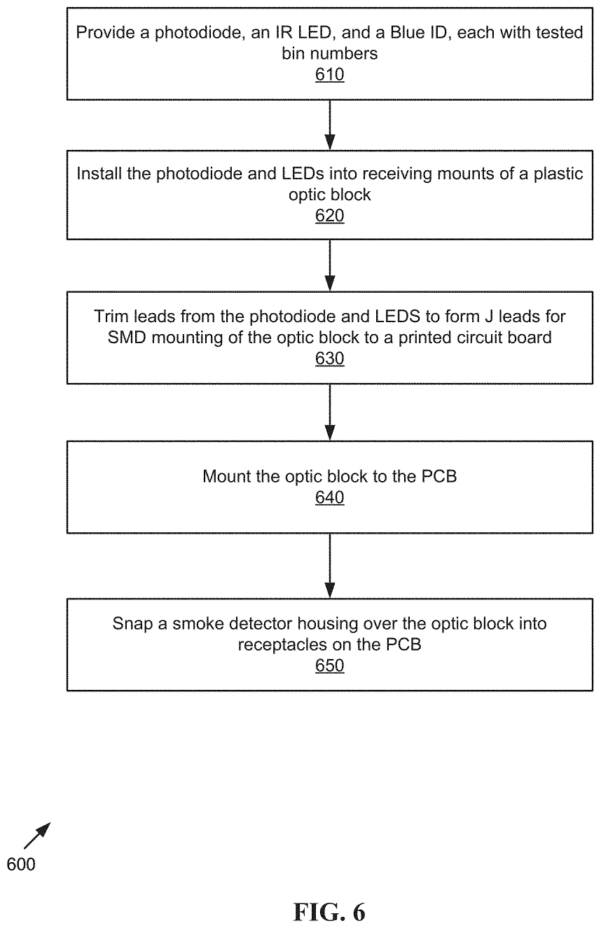

FIG. 6 is a flowchart of an exemplary method embodiment for making a smoke detector. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A photodiode, an IR LED, and a Blue LED, are provided, each with tested bin numbers, as shown by block 610. The photodiode and LEDs are installed into receiving mounts of a plastic optic block, as shown by block 620. The leads of the photodiode and LEDS are trimmed to form J leads for mounting the optic block to a printed circuit board, as shown by block 630. The optic block is mounted to the PCB, as shown by block 640. A smoke detector housing is snapped over the optic block into receptacles on the PCB, as shown by block 650.

Advantages of the above described embodiments over previous smoke detectors include:
An SMD optic block for a simplified and less costly manufacturing process,
An improved interaction volume providing less sensitivity to pointing error leading to improved smoke detection sensitivity and tighter transfer function by the use of the flat design of the optical tunnel.
An improved clear air signal due to the chamber roof features.

The SMD optic block allows a lower cost for manufacturing. In comparison, for a two part smoke chamber, the manufacturing tolerances will lead to an expensive smoke chamber base allowing SMD mounting or a through hole assembly of the LEDs and photodiode. The use of the optic block allows SMD assembly techniques while maintaining low cost.

The large interaction volume also allows cost reduction while maintaining good detection threshold by reducing the need for tight pointing accuracy of the LEDs and photodiode, since tight pointing error is achieved by tight mechanical tolerance on LEDs and photodiode which raise the cost of these components.

The smoke chamber design allows lower detection threshold by reducing the clean air signal due to the labyrinth, the cone, and the round features on the smoke chamber cap. The smoke chamber design widens the light interaction volume allowing wider tolerance for component placement and selection, ultimately reducing the cost of the sensor.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A photo-electric smoke detector assembly comprising:
an optic block further comprising:
a Y-shaped mount comprising a first end configured to mount a first photo-electronic device and a second end opposite the first end configured to mount a second photo-electronic device and third photo-electronic device adjacent to the second photo-electronic device, so each of the photo-electronic devices is directed toward an interaction volume adjacent to a midpoint of the optic block between the first end and the second end;
the Y-shape mount first end comprises a first optical axis of the first photo-electronic device, and the Y-shaped second end comprises:
a second optical axis of the second photo-electronic device oriented at a second angle β with respect to the first optical axis in a plane parallel to a mounting plane of the optic block; and
a third optical axis of the third photo-electronic device oriented at a third angle δ with respect to the first optical axis in the plane parallel to the mounting plane,
wherein an angle θ between the second optical angle and the third optical angle is equal to δ+β in the plane parallel to the mounting plane,
the first, second, and third photo-electronic devices consist of:
a first emitter configured to produce a pulse of light of a first wavelength directed toward the interaction volume;
a second emitter configured to produce a pulse of light of a second wavelength different from the first wavelength directed toward the interaction volume; and
a photo detector configured to receive light from the first emitter and the second emitter scattered off of smoke particles in the interaction volume, and
the first, second, and third photo-electronic devices are mounted with an orientation directing the respective emitter or detector at a first angle α in the range of 20 to 25 degrees with respect to the mounting plane of the optic block.

2. The smoke detector assembly of claim 1, wherein the optic block further comprises:
a first flat-channel path between the first photo-electronic device and the interaction volume;
a second flat-channel path between the second photo-electronic device and the interaction volume; and
a third flat-channel path between the third photo-electronic device and the interaction volume.

3. The smoke detector assembly of claim 2, where the first, second, and third flat channel path comprises a surface texture finish configured to provide a predetermined interaction volume of the emitter and detector field of view.

4. The smoke detector assembly of claim 1, further comprising:
a housing having a substantially circular cross-sectional profile providing a smoke chamber configured to substantially surround the optic block and interaction volume, comprising:
a chamber base disposed around the optic block further comprising:
a chamber base aperture configured to provide an optical path from the first, second and third flat-channel path to the chamber;
a smoke permeable labyrinth comprising a plurality of interleaved baffles forming a perimeter of the chamber, wherein the baffles are arranged to prevent ingress of direct ambient light into the chamber; and
a chamber roof comprising an interior surface bounding the chamber, the chamber roof further comprising:
a conical structure protruding into the chamber with a conical structure apex coinciding with a center of the circular housing disposed adjacent to the interaction volume; and
a plurality concentric circular structures within the labyrinth centered at the conical structure apex surrounding the central conical structure on the interior of the chamber roof and protruding into the chamber.

5. The smoke detector assembly of claim 1, wherein the optic block is configured to be mounted upon a printed circuit board via a surface mount arrangement.

6. The smoke detector assembly of claim 5, further comprising an electromagnetic interference (EMI) shield disposed upon the photo detector.

7. The smoke detector assembly of claim 5, wherein metal leads for the first, second, and third photo-electronic devices are each formed in a J shape and inserted into the optic block.

8. The smoke detector assembly of claim 1, wherein the optic block is configured to be mounted upon a printed circuit board via through-hole arrangement.

9. The smoke detector assembly of claim 1, wherein the first photo-electronic device comprises the photo-detector, the second photo-electronic device comprises the first emitter, and the third photo-electronic device comprises the second emitter.

10. The smoke detector assembly of claim 1, wherein the first photo-electronic device comprises the first emitter, the second photo-electronic device comprises the photo-detector, and the third photo-electronic device comprises the second emitter.

11. The smoke detector assembly of claim 1, further comprising a dust collector cavity disposed at a middle intersection portion between the first and second end of the optic block.

12. The smoke detector assembly of claim 4, further comprising a metal mesh configured to encircle the smoke chamber.

13. A smoke detector assembly comprising:
an optic block comprising a first end and a second end opposite the first end, the first end configured to mount an emitter configured to produce a pulse of light directed toward an interaction volume adjacent to a midpoint of the optic block between the first end and the second end, the second end configured to mount a photo detector configured to receive light from the first emitter scattered off of smoke particles in the interaction volume;
a first flat-channel path disposed between the emitter and the interaction volume; and
a second flat-channel path disposed between the photo detector and the interaction volume,
wherein the emitter and photo detector are mounted directing the respective emitter or detector at an angle α in the range of 20 to 25 degrees with respect to a mounting plane of the optic block.

14. The smoke detector assembly of claim 13, where the first and second flat channel paths comprises a surface texture finish configured to provide a predetermined interaction volume of the emitter and detector field of view.

15. The smoke detector assembly of claim 13, further comprising:
a housing having a substantially circular cross-sectional profile providing a smoke chamber configured to substantially surround the optic block and interaction volume, comprising:
a chamber base disposed around the optic block further comprising:
a chamber base aperture configured to provide an optical path from the first and second flat-channel path to the chamber;
a smoke permeable labyrinth comprising a plurality of interleaved baffles forming a perimeter of the chamber, wherein the baffles are arranged to prevent ingress of direct ambient light into the chamber; and
a chamber roof comprising an interior surface bounding the chamber, the chamber roof further comprising:
a conical structure protruding into the chamber with a conical structure apex coinciding with a center of the circular housing disposed adjacent to the interaction volume; and
a plurality concentric circular structures within the labyrinth centered at the conical structure apex surrounding the central conical structure on the interior of the chamber roof and protruding into the chamber.

16. The smoke detector assembly of claim 13, further comprising a dust collector cavity disposed at a middle intersection portion between the first and second end of the optic block.

17. The smoke detector assembly of claim 13, wherein the optic block is configured to be mounted upon a printed circuit board via a surface mount arrangement.

18. The smoke detector assembly of claim 17, wherein metal leads for the emitter and photo detector are each formed in a J shape and inserted into the optic block.

19. The smoke detector assembly of claim 13, wherein the optic block is configured to be mounted upon a printed circuit board via through-hole arrangement.

20. The smoke detector assembly of claim 17, further comprising an electromagnetic interference (EMI) shield disposed upon the photo detector.

21. The smoke detector assembly of claim 15, further comprising a metal mesh configured to encircle the smoke chamber.

22. A smoke detector assembly comprising:
an optic block comprising a first end and a second end opposite the first end, the first end configured to mount an emitter configured to produce a pulse of light directed toward an interaction volume adjacent to a midpoint of the optic block between the first end and the second end, the second end configured to mount a photo detector configured to receive light from the first emitter scattered off of smoke particles in the interaction volume;
a housing having a substantially circular cross-sectional profile providing a smoke chamber configured to substantially surround the optic block and interaction volume, comprising:
a chamber base disposed around the optic block further comprising:
a chamber base aperture configured to provide an optical path from the optic block to the chamber;
a smoke permeable labyrinth comprising a plurality of interleaved baffles forming a perimeter of the chamber, wherein the baffles are arranged to prevent ingress of direct ambient light into the chamber; and
a chamber roof comprising an interior surface bounding the chamber, the chamber roof further comprising:
a conical structure protruding into the chamber with a conical structure apex coinciding with a center of the circular housing disposed adjacent to the interaction volume; and
a plurality concentric circular structures within the labyrinth centered at the conical structure apex surrounding the central conical structure on the interior of the chamber roof and protruding into the chamber,
wherein the emitter and photo detector are mounted directing the respective emitter or detector at an angle α in the range of 20 to 25 degrees with respect to a mounting plane of the optic block.
